(19) United States
(12) Patent Application Publication
(10) Pub. No.: US 2025/0092723 A1
(43) Pub. Date: Mar. 20, 2025

(54) VEHICULAR ACTUATOR WITH PLUNGER AND SLEEVE SEAL

(71) Applicant: Magna Mirrors of America, Inc., Holland, MI (US)

(72) Inventors: Bryce A. Hilborn, Grand Rapids, MI (US); Justin E. Sobecki, Rockford, MI (US)

(21) Appl. No.: 18/830,830

(22) Filed: Sep. 11, 2024

Related U.S. Application Data
(60) Provisional application No. 63/582,537, filed on Sep. 14, 2023.

(51) Int. Cl. E05B 85/10; E05B 81/04

(52) U.S. Cl. CPC E05B 85/107; E05B 81/04

(57) ABSTRACT

A vehicular exterior door handle assembly includes a base portion, a handle portion and an actuator. The actuator is electrically operable to move the handle portion relative to the base portion between a recessed position and a deployed position. The actuator includes a housing, an electrically operable motor disposed within the housing and a plunger disposed partially within the housing. The plunger extends from within the housing along a passageway of the housing and partially exterior the housing. The actuator, when operated, drives the plunger axially along the passageway of the housing to move the handle portion between the recessed position and the deployed position. The plunger extends through a sleeve within the housing, and the sleeve engages the plunger and an inner surface of the housing at or near the passageway to preclude moisture from entering the housing.

### CROSS REFERENCE TO RELATED APPLICATION

The present application claims the filing benefits of U.S. provisional application Ser. No. 63/582,537, filed Sep. 14, 2023, which is hereby incorporated herein by reference in its entirety.

### FIELD OF THE INVENTION

The present invention relates to handles for vehicles and, more particularly, to an exterior handle for opening a side door and/or liftgate of a vehicle.

### BACKGROUND OF THE INVENTION

A door handle for a vehicle door typically includes a handle portion that is pivotable relative to a base portion, whereby pivotal movement of the handle portion actuates a latch mechanism to open the door. Typically, a door handle is a pull strap handle with a strap handle portion that protrudes outwardly from the side of the vehicle for grasping by the person opening the door of the vehicle. Alternately, paddle type door handle assemblies are known, where a paddle portion is pivotally mounted to a base portion and is pulled generally outwardly and upwardly to open the vehicle door. Such paddle type door handle assemblies typically protrude outwardly from the vehicle door when in their unpulled state and have an open recess below the paddle portion for receiving a user's fingers for grasping the paddle portion.

### SUMMARY OF THE INVENTION

A vehicular exterior door handle assembly includes a base portion configured to mount at a door of a vehicle equipped with the vehicular exterior door handle assembly. A handle portion of the vehicular exterior door handle assembly includes a grasping portion. The handle portion is movable relative to the base portion between (i) a recessed position, where the grasping portion of the handle portion is recessed at the base portion and not graspable by a user, and (ii) a deployed position, where the grasping portion of the handle portion protrudes outward from the base portion and is graspable by the user. An actuator is operable to move the handle portion between the recessed position and the deployed position. The actuator includes (i) a housing, (ii) an electrically operable motor disposed at an interior portion of the housing and (iii) a plunger that extends from the interior portion of the housing along a passageway formed through the housing and exterior the housing. The actuator, when the electrically operable motor is electrically operated, axially drives the plunger along the passageway of the housing to move the handle portion between the recessed position and the deployed position. The actuator includes a sleeve at the interior portion of the housing, and the plunger extends along the sleeve. The sleeve engages the plunger and an inner surface of the housing at or near the passageway to preclude moisture from entering the interior portion of the housing.

For example, the sleeve includes an inner cylindrical surface of compressible material that engages an outer surface of the plunger. The sleeve may also include an O-ring compressed between a body portion of the sleeve and the inner surface of the housing. Optionally, the sleeve includes a collar that extends from a body of the sleeve and at least partially along the passageway of the housing to form an interference fit between the collar and the passageway of the housing. The body portion of the sleeve includes ramped surfaces that engage corresponding ramped surfaces of the housing to urge the sleeve into engagement with the inner surface of the housing.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with an extendable flush door handle assembly;

FIG. 2 is an enlarged perspective view of the extendable flush door handle assembly of FIG. 1 at the vehicle door, with the door handle in its flush or non-use or recessed position;

FIG. 3 is a perspective view of an actuator that is operable to axially drive a plunger to move the door handle between its recessed position and its extended or use position;

FIG. 4 is a plan view of the actuator of FIG. 3, with a lower housing portion removed;

FIG. 5 is a plan view of the actuator of FIG. 3, with an upper housing portion removed;

FIG. 6 is a perspective view of the actuator of FIG. 3, with the upper housing portion removed;

FIG. 7 is a perspective view of the actuator of FIG. 3, with the lower housing portion removed;

FIGS. 8-11 are views of a sleeve disposed within the housing of the actuator of FIG. 3 to provide seals between the housing and the sleeve and between the plunger and the sleeve;

FIGS. 12 and 13 are sectional views of the actuator of FIG. 3;

FIG. 14 is a perspective view of another actuator that is operable to axially drive a plunger to move the door handle between its recessed position and its extended position;

FIG. 15 is a plan view of the actuator of FIG. 14, with the upper housing portion removed;

FIG. 16 is a plan view of the actuator of FIG. 14, with the lower housing portion removed;

FIG. 17 is a perspective view of the actuator of FIG. 14, with the upper housing portion removed;

FIG. 18 is a perspective view of the actuator of FIG. 14, with the lower housing portion removed;

FIG. 19 is another perspective view of the actuator of FIG. 14;

FIGS. 20-23 are views of a sleeve disposed within the housing of the actuator of FIG. 14 to provide seals between the housing and the sleeve and between the plunger and the sleeve; and

FIGS. 24-28 are sectional views of the actuator of FIG. 14.

### DESCRIPTION OF THE PREFERRED EMBODIMENTS

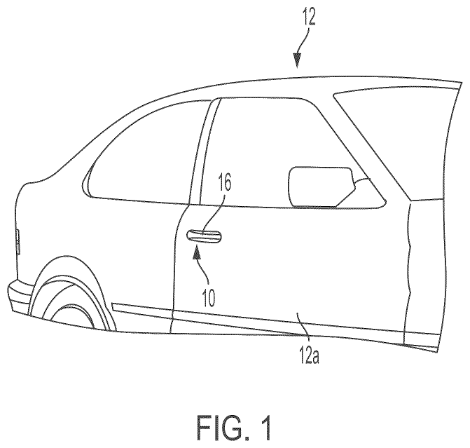

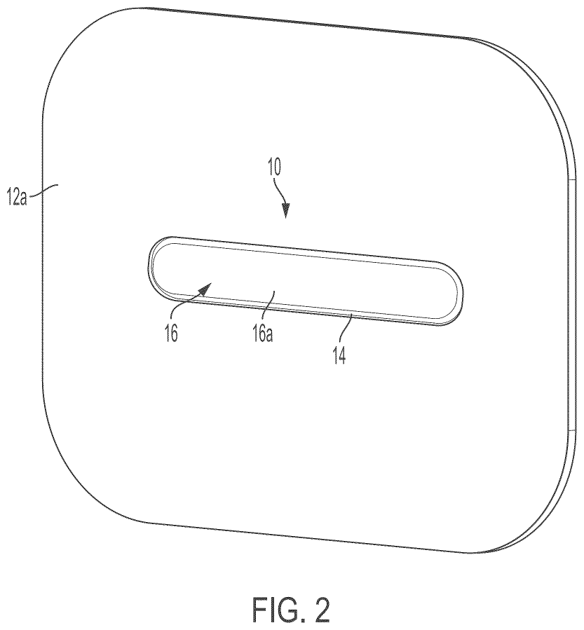

Referring now to the drawings and the illustrative embodiments depicted therein, a vehicular handle assembly or module or unit or extendable flush door handle assembly 10 is mountable to a door 12a of a vehicle 12 and operable to release a latch mechanism of the vehicle door 12a to open the vehicle door (FIGS. 1 and 2). The vehicular handle assembly 10 may include a base portion or bracket 14 that is mountable to the vehicle door 12a and a handle or strap portion 16 that is pivotally mounted to the bracket 14. When not in use, the handle portion 16 is at an initial rest or recessed or non-use position and is received or disposed at or partially in the base portion 14 so that an outer surface 16a of the handle portion 16 is generally flush with or generally coplanar with (or protruding only slightly from or recessed slightly in) the outer surface of the door panel 12a, whereby the handle portion 16 is not readily usable or graspable by a user (FIG. 2). The handle portion 16 is electromechanically pivotable or movable or laterally movable relative to the door and the base portion 14 to move to its extended or ready or operational or grippable or graspable or person-operable position, where the handle portion 16 is extended from the door 12a and is then graspable or grippable by a user where the handle portion 16 may be manually moved (such as via pulling by the user) further beyond the extended position to actuate or release the latch mechanism of the door to open the vehicle door. The handle assembly 10 includes an electrically operable or electromechanical actuator 18 at the base portion 14 for imparting the pivotal movement of the handle portion 16 relative to the base portion 14 (such as automatically imparting such handle movement in response to a signal from a key fob or a passive entry system or the like) so that the handle portion 16 is automatically moved from its recessed position to its ready or graspable position where a user can grasp the handle portion to pull or move the handle portion for unlatching and/or opening the vehicle door and/or the like.

The handle assembly 10 may comprise any suitable type of handle assembly, and may include or incorporate aspects of the door handle assemblies described in U.S. Pat. Nos. 8,786,401; 6,977,619; 7,407,203 and/or 8,333,492, and/or U.S. Publication Nos. US-2022-0341226; US-2022-0282534; US-2022-0018168 and/or US-2020/0102773, which are all hereby incorporated herein by reference in their entireties. Optionally, aspects of the handle assembly 10 and/or the actuator 18 may be suitable for use with a liftgate handle assembly for a liftgate or tailgate of a vehicle. The actuator may comprise any suitable type of actuator, such as a variable torque/variable speed actuator and may utilize aspects of the actuators described in U.S. Publication Nos. US-2024-0035318; US-2022-0341226 and/or US-2022-0282534, which are all hereby incorporated herein by reference in their entireties. Although shown and described as pivoting the door handle, the actuator and handle mechanism may be configured to cause lateral or non-pivoting movement of the door handle relative to the base portion.

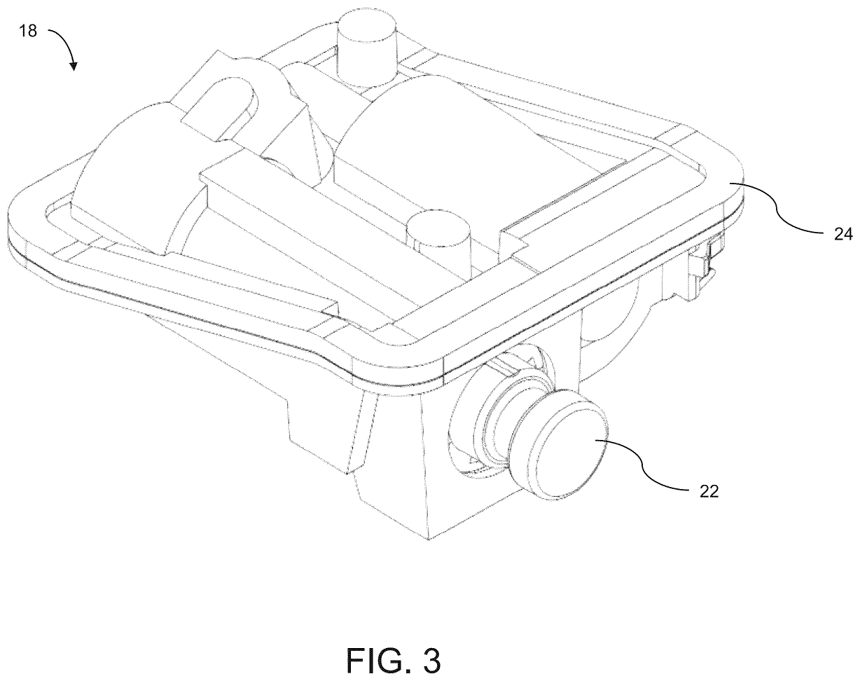

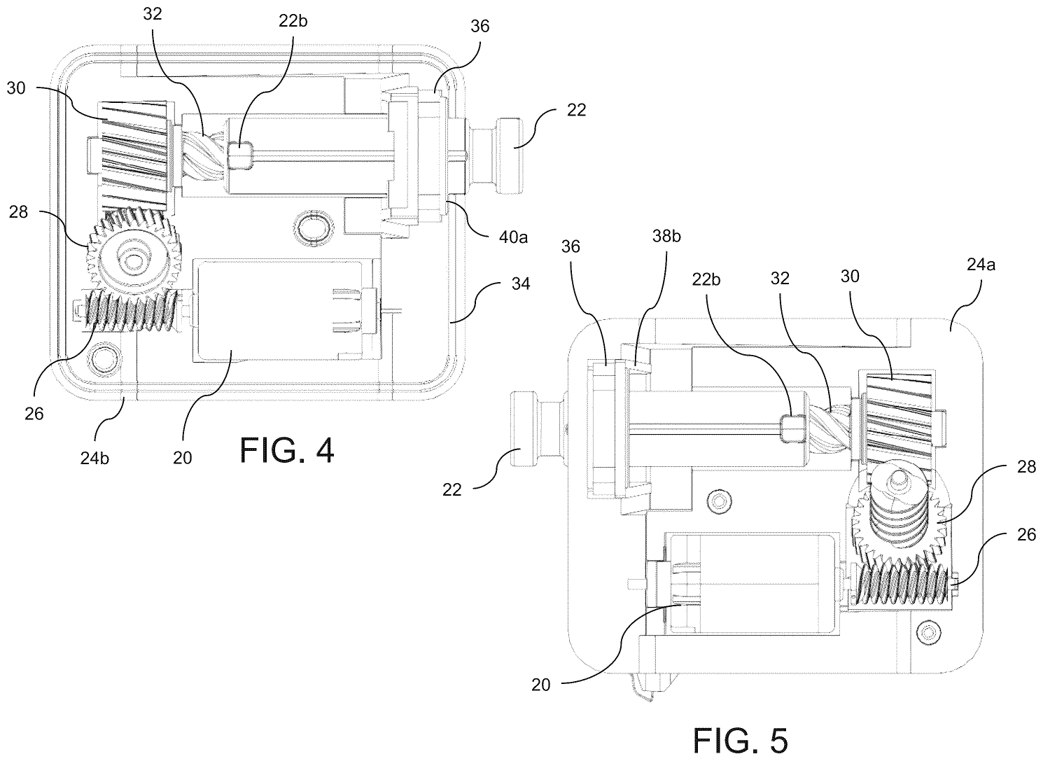

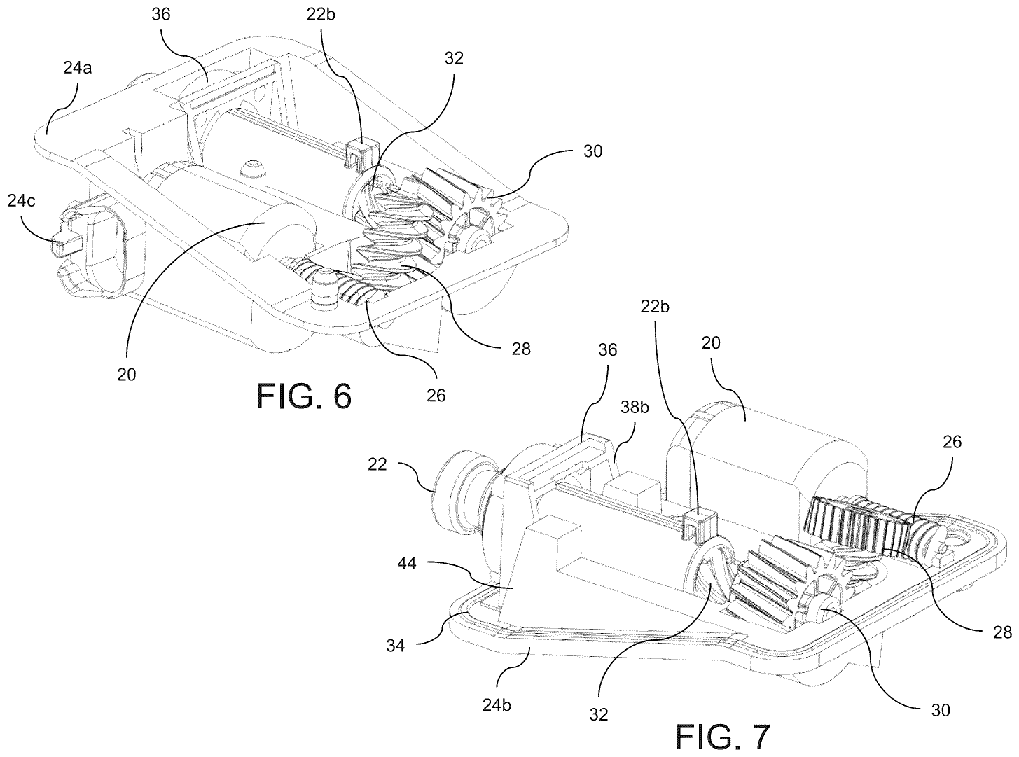

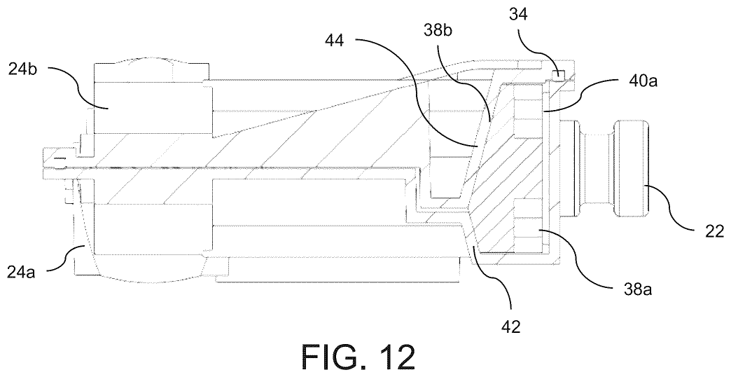

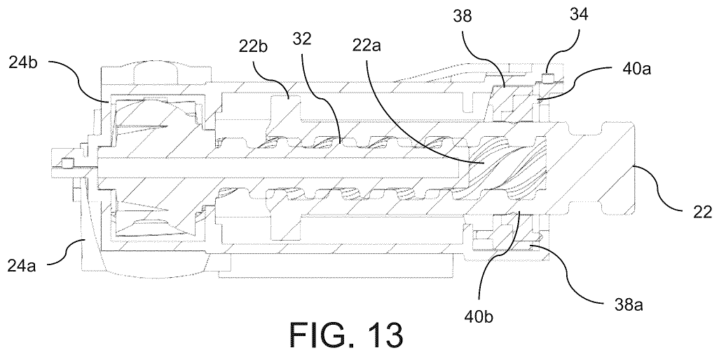

Referring to FIGS. 3-13, the actuator 18 includes an electrically operable motor 20 that, when the actuator 18 is electrically operated to move the door handle between the retracted position and the extended position, imparts movement of a plunger 22 of the actuator 18 to move the handle between the retracted position and the extended position. In other words, the actuator 18 axially moves the plunger 22 between a retracted state and an extended state to impart movement of the door handle. For example, the plunger 22 may engage an output element connected to the door handle and the plunger 22 may impart movement of the output element when moved between the retracted and extended states to pivot the door handle between the retracted and extended positions.

The actuator 18 includes a housing 24 (that may include a first or lower housing portion 24a and a second or upper housing portion 24b that join together to form a housing cavity) that houses or accommodates the motor 20 and a gear train. When the motor 20 is electrically operated, the motor 20 rotates gears of the gear train to impart movement of the plunger 22 relative to the housing 24. In the illustrated example, the motor 20 rotatably drives a worm gear 26 that engages with and drives a helical cluster gear 28 that is rotatably mounted at the housing 24. The helical cluster gear 28 includes a worm gear element that engages a helical gear 30, which is rotated when the motor is operated. The plunger 22 is movably coupled to the helical gear 30 via a lead screw 32, which is rotated according to rotation of the helical gear 30.

The lead screw 32 is received at least partially along a gear passageway 22a of the plunger 22 and the plunger 22 includes one or more tabs or elements or wings 22b that are received in respective channels of the housing 24 to preclude rotation of the plunger 22 during rotation of the lead screw 32. Thus, as the lead screw 32 is rotatably driven, the lead screw 32 rotates relative to the plunger 22 and the plunger translationally moves along the lead screw 32 relative to the housing 24 between the retracted state and the extended state. Optionally, the gear train rotatably connecting the motor 20 and the variable lead screw 32 responsible for translational movement of the plunger 22 may comprise any number of gears. Because the plunger 22 is rotationally fixed relative to the actuator housing 24 and thus does not rotate as the variable lead screw 32 is rotatably driven, the plunger 22 translates along the variable lead screw 32 according to rotation of the variable lead screw 32.

The lower housing 24a and the upper housing 24b join together to from a cavity or recess that houses the electrically operable motor 20, the gear train, and at least a portion of the plunger 22. A compressible seal or gasket 34 is disposed between the lower housing 24a and the upper housing 24b and circumscribing the cavity of the housing 24 so that, when the housing portions are joined together, the seal 34 is compressed between the housing portions and forms a barrier to preclude entrance of moisture, dust, and other contaminants into the housing 24. Further, the housing 24 may include a connector portion 24c for electrically connecting the actuator 18 to a wiring harness of the vehicle, such as for electrically powering the actuator 18 and/or controlling operation of the actuator 18.

The plunger 22 extends through an aperture or through hole or passageway of the housing 24 and, when the plunger 22 is moved between the retracted state and the extended state, the plunger 22 moves along and through the passageway relative to the housing 24. For example, the passageway is formed through a wall of the lower housing portion 24a. An inner diameter of the passageway of the housing 24 may be greater than an outer diameter of the plunger 22 to allow for movement of the plunger 22 through and along the passageway. As discussed further below, a sleeve or gasket element 36 is disposed within the housing 24 and at least partially circumscribes an opening of the passageway at the inner surface of the housing 24, with the plunger 22 extending through or along the sleeve 36 and the passageway. The sleeve 36 engages the inner surface of the housing 24 at or near or circumscribing the opening of the passageway and an outer surface of the plunger 22 as the plunger 22 moves along the sleeve 36 to form a seal or barrier at the passageway that precludes entrance of moisture, dust, and other contaminants into the housing 24 at the plunger passageway.

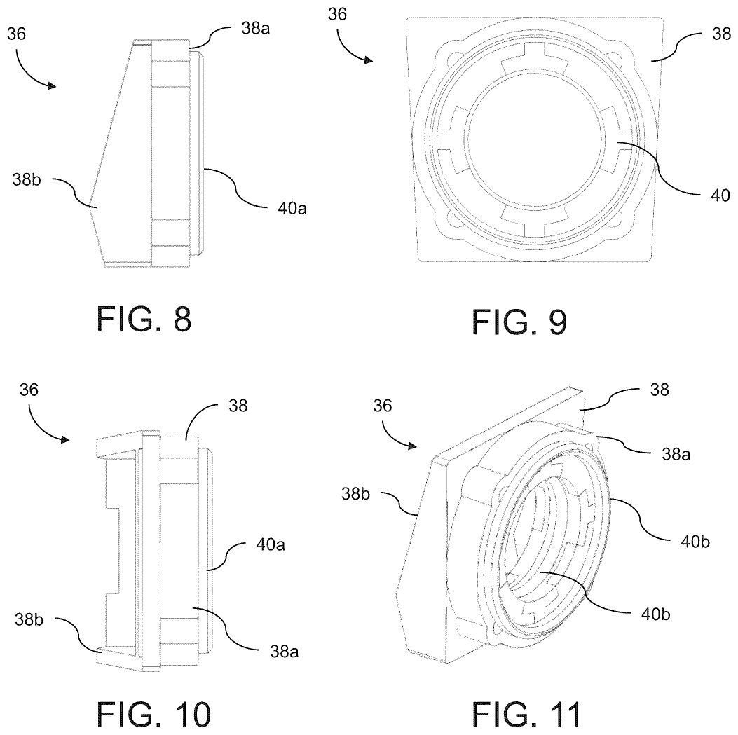

As shown in FIGS. 8-13, the sleeve element 36 includes a body portion 38 and a sealing or gasket portion 40, where the body portion 38 comprises a compression resistant material, such as a plastic material, and the sealing portion 40 comprises a compressible material, such as a rubber material overmolded at the body portion 38. The body portion 38 includes a disk or wedge-shaped insert having a passageway formed therethrough and that is disposed within the housing 24 so that the plunger 22 extends through the passageway of the body portion 38. A first side 38a of the sleeve body 38 faces the inner wall of the housing 24 at or near or surrounding or circumscribing the passageway of the housing 24, and optionally engages the inner surface of the housing 24. A second side 38b of the sleeve body 38 opposite the first side 38a includes a ramped interface for engaging corresponding ramped surfaces of the lower housing portion 24a and the upper housing portion 24b. Thus, when the housing portions are joined together, a ramped surface 42 of the lower housing portion 24a and a ramped surface 44 of the upper housing portion 24b engage the ramped interface 38b of the sleeve body 38 to urge the sleeve element 36 toward the inner wall of the housing at which the housing passageway is formed.

A series of channels or recesses may extend at least partially through the body portion 38 so that the overmolded sealing portion 40 extends along and substantially fills the channels and recesses to preclude the sealing portion 40 from pulling out of or away from the body portion 38. That is, the sealing portion 40 substantially conforms to the channels and recesses of the body portion 38 to secure the sealing portion 40 relative to the body portion 38.

A first portion 40a of the sealing portion 40 is disposed at the first side 38a of the body portion and circumscribes the sleeve passageway and the plunger 22. For example, the first portion 40a of the sleeve seal 40 may include an O-ring seal. Thus, when the sleeve element 36 is urged toward the inner wall of the housing 24, the first portion 40a of the seal 40 is compressed between the first side 38a of the body portion 38 and the lower housing 24a to create a seal against the face of the housing wall. An inner diameter of the first portion 40a of the seal 40 may be greater than the outer diameter of the plunger 22.

A second portion 40b of the sealing portion 40 is disposed along the passageway of the body portion 38 and engages an outer surface of the plunger 22. The second portion 40b maintains engagement with the outer surface of the plunger 22 as the plunger 22 moves between the retracted state and the extended state to maintain a seal at the plunger 22. For example, the second portion 40b may be compressed between the plunger 22 and the inner surface of the sleeve body 38 forming the passageway. Thus, an inner diameter of the second portion 40b may be less than or equal to the outer diameter of the plunger 22.

That is, a rubber material that forms the seal or sealing portion 40 is overmolded onto the seal body 38. The second portion 40b of the sealing portion 40 seals the plunger 22 along the passageway of the sleeve 36. The first portion 40a of the sealing portion 40 is disposed at the first side or face 38a of the seal body 38 and seals the sleeve 36 against the inner surface of the lower housing 24a. The ramped interface 38b (which may include one or more or two or more ramped surfaces at the second side of the seal body) engages with respective ramps of the lower housing 24a and the upper housing 24b to force the sleeve 36 into engagement with the lower housing 24a and to compress the rubber material of the seal 40 on the sleeve 36 against the wall of the lower housing 24a to achieve a seal against moisture, dust, and other contaminants from entering the actuator housing 24.

In other words, the actuator 18 includes a sleeve 36 circumscribing the plunger 22 and with rubber or compressible or elastomeric material overmolded onto a body 38 of the sleeve 36. The sleeve 36 is forced into the lower housing 24a to compress the rubber material and create a seal between the housing and the sleeve 36. Ramps of the housing are used in combination with ramps of the sleeve 36 urge the sleeve 36 into engagement with the housing and create the seal. For example, the seal may be created with overmolded rubber or an O-ring disposed between the wall of the lower housing 24a and the sleeve 36.

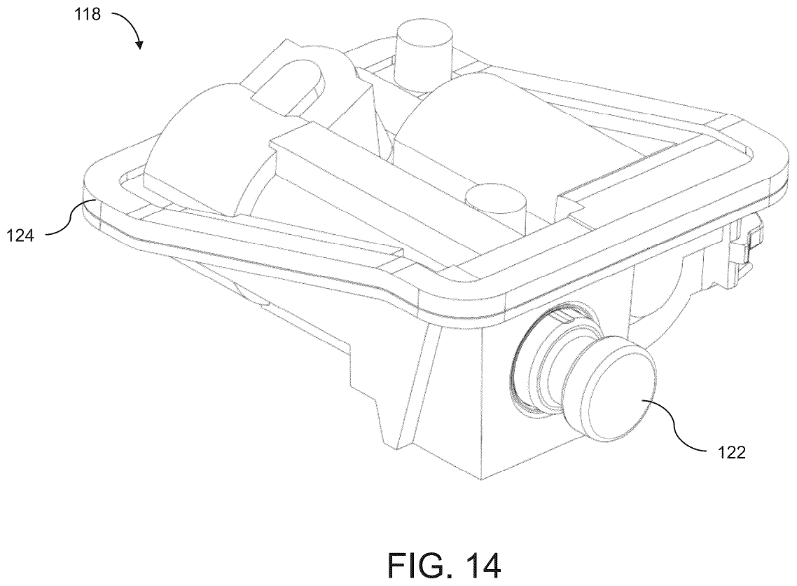

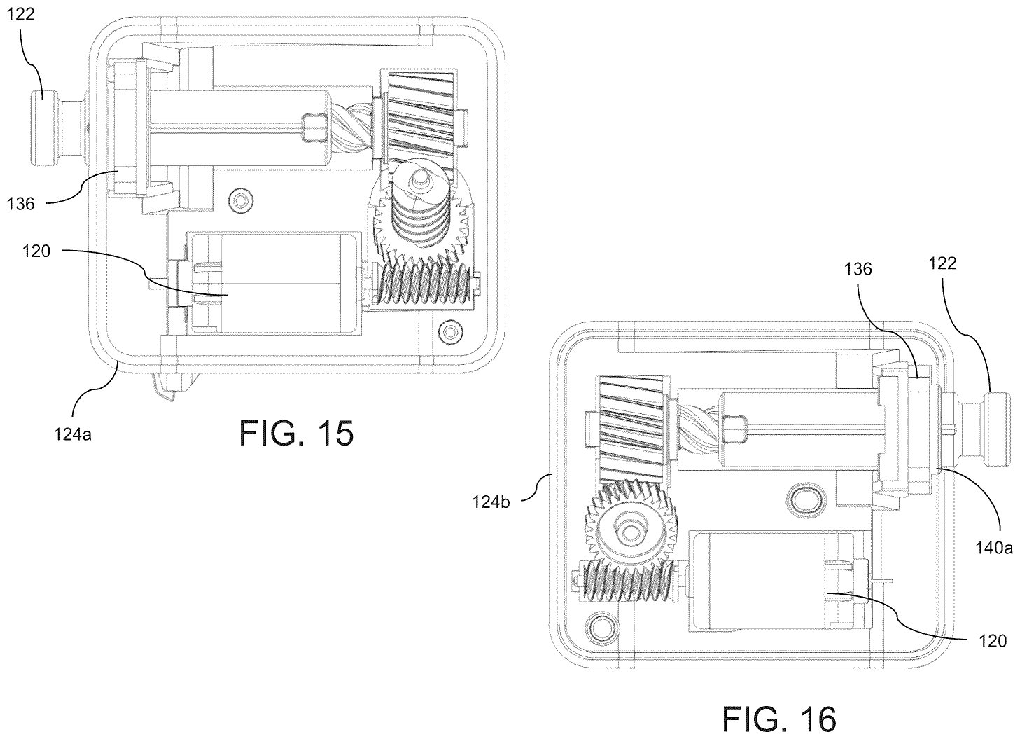

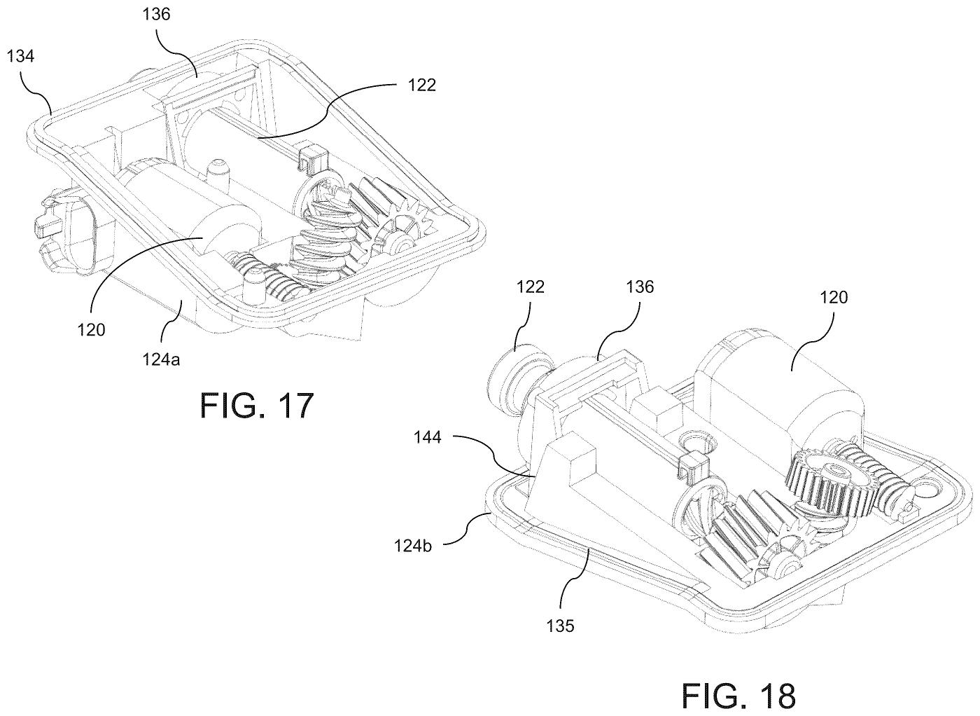

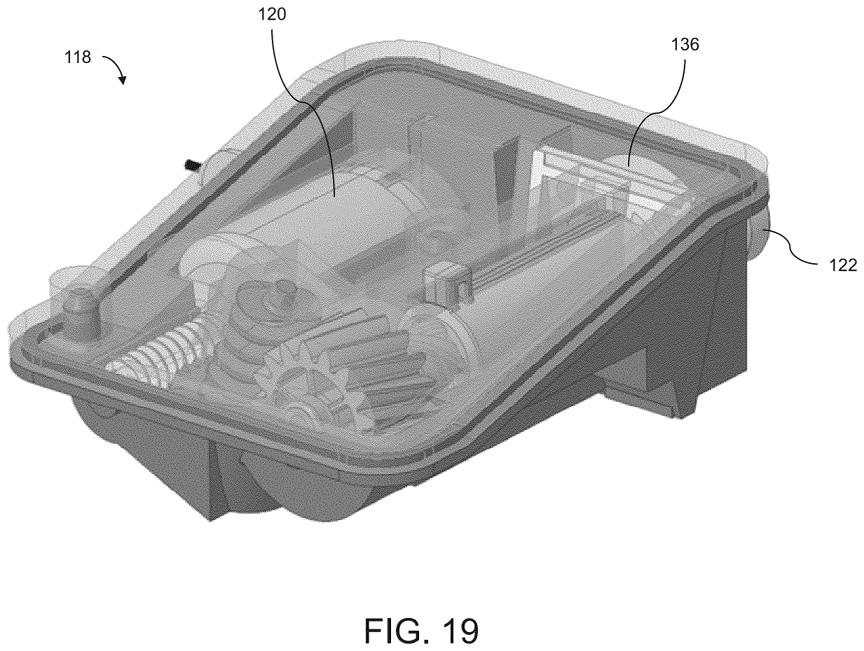

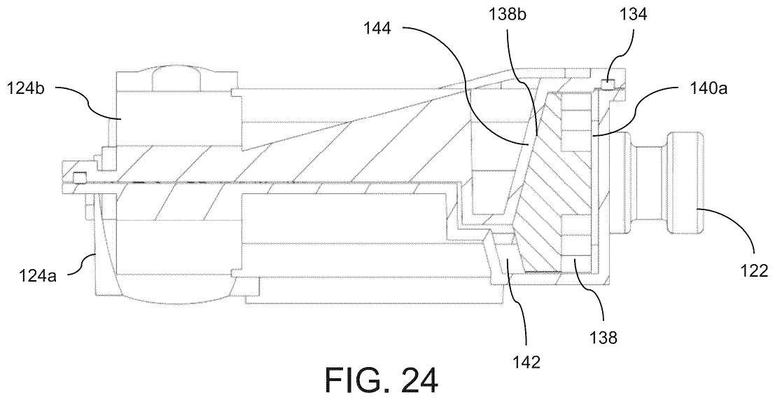

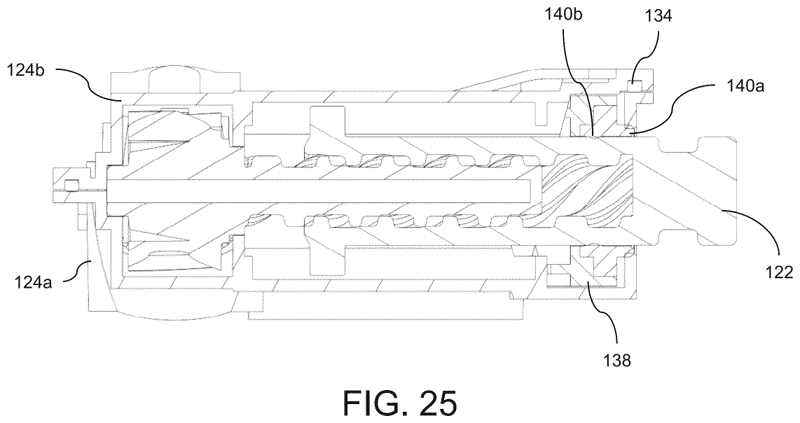

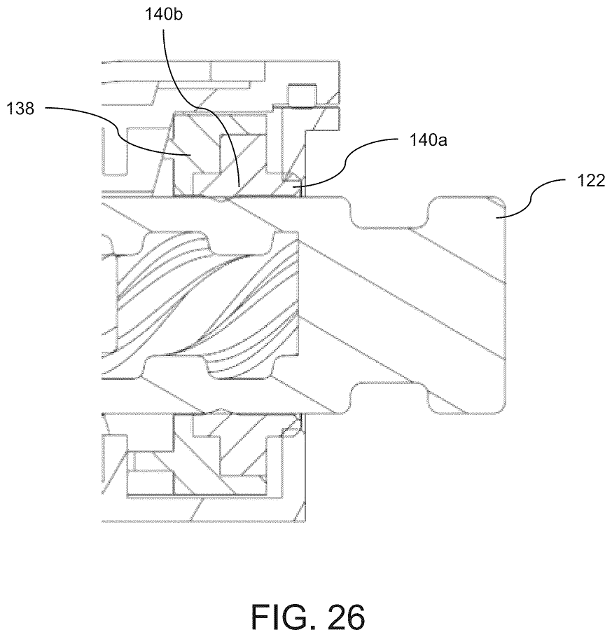

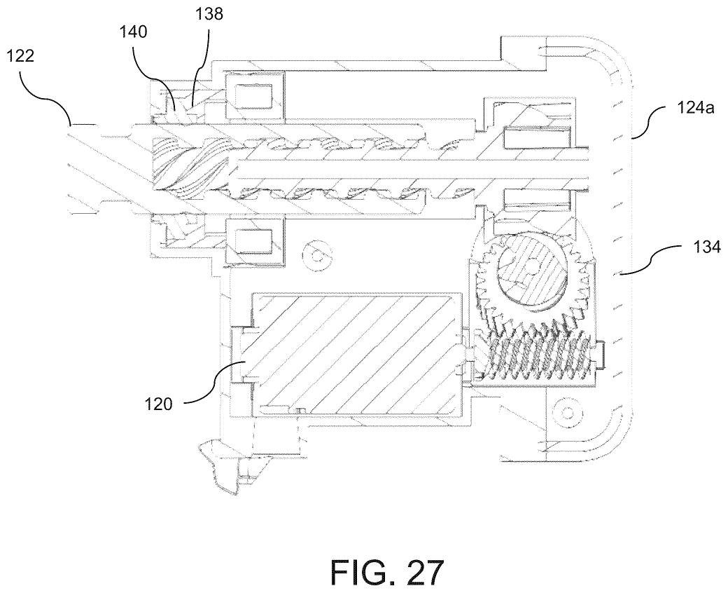

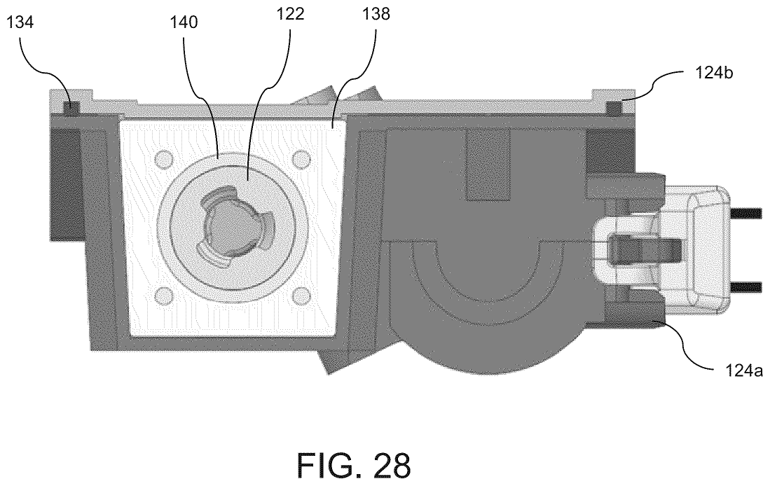

Referring to FIGS. 14-28, an actuator 118 may include a sleeve element 136 where the sealing portion 140 includes a hoop or collar portion 140a that extends at least partially along the outer surface of the plunger 122 and at least partially along the passageway of the actuator housing 124 to form a seal along the passageway of the housing 124. The collar portion 140a includes an outer diameter that is greater than an inner diameter of the passageway of the actuator housing 124 to form an interference fit between the outer surface of the collar portion 140a and the inner surface of the housing passageway, thus forming a seal between the sleeve 136 and the actuator housing 124 to preclude entrance of moisture, dust, and other contaminants into the actuator housing 124. The sealing portion 140 further includes a second portion 140b along the passageway of the sleeve body 138 that engages the outer surface of the plunger 122 for forming a seal between the sleeve 136 and the plunger 122 to preclude entrance of moisture, dust, and other contaminants into the actuator housing 124. Optionally, the collar portion 140a is compressed between the passageway of the housing 124 and the plunger 122 to further seal the opening through the housing 124.

The body portion 138 of the sleeve 136 includes a passageway, and the sleeve 136 is disposed at the interior portion of the actuator housing 124 to interface with an inner surface or wall of the housing 124 at or near or surrounding or circumscribing the opening of the passageway of the actuator housing 124. The plunger 122 extends along and through the passageway of the sleeve 136 and the passageway of the actuator housing 124. Thus, when the electrically operable motor 120 is electrically operated to move the plunger 122 between the retracted state and the extended state, the plunger 122 moves axially along the passageway of the sleeve 136 and the passageway of the actuator housing 124.

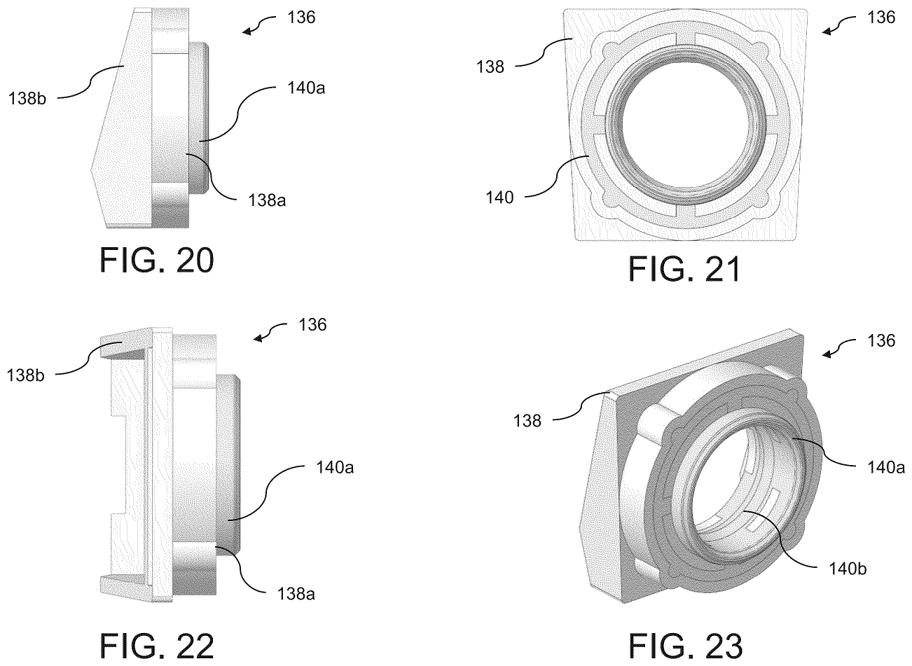

As shown in FIGS. 20-28, the sealing portion 140 comprises a compressible or elastomeric material, such as a rubber material overmolded at the body portion 138. The body portion 138 includes a disk or wedge-shaped insert having the passageway formed therethrough. A first side 138a of the sleeve body 138 faces, and optionally engages, the inner wall of the housing 124 at or near or surrounding or circumscribing the passageway of the housing 124. A second side 138b of the sleeve body 138 opposite the first side 138a includes a ramped interface for engaging corresponding ramped surfaces of the lower housing portion 124a and the upper housing portion 124b. Thus, when the housing portions are joined together, a ramped surface 142 of the lower housing portion 124a and a ramped surface 144 of the upper housing portion 124b engage the ramped interface 138b of the sleeve body 138 to urge the sleeve element 136 toward the inner wall of the housing.

A series of channels or recesses may extend at least partially through the body portion 138 so that the overmolded sealing portion 140 extends along and substantially fills the channels and recesses to preclude the sealing portion 140 from pulling out of or away from the body portion 138. That is, the sealing portion 140 substantially conforms to the channels and recesses of the body portion 138 to secure the sealing portion 140 relative to the body portion 138.

The collar portion 140a of the seal 140 extends from the first side 138a of the body portion 138 and at least partially along the plunger 122 and the passageway of the housing 124. The passageway through the lower housing 124a is sized to accommodate the collar 140a. That is, at least a portion of the passageway of the housing 124 has an inner diameter that is greater than the outer diameter of the plunger 122 and less than the diameter of the collar 140a. For example, a first portion of the passageway extending from the inner surface of the housing 124 may have a first diameter and a second portion of the passageway extending from the first portion to the outer surface of the housing 124 may have a second diameter that is less than the first diameter. The collar 140a extends along the first portion of the passageway and engages the inner surface of the housing along the first portion of the passageway.

The ramped surface 138b of the sleeve body 138 engages the corresponding ramped surfaces of the housing to urge the collar 140a toward the inner surface of the housing 124 and along the passageway of the housing. In other words, the ramps force the sleeve seal 140 into the hole or passageway in the lower housing and the seal between the sleeve 136 and the lower housing 124a is created using an interference fit between the two diameters of the sealing portion 140 and the channel of the housing.

The second portion 140b of the sealing portion 140 is disposed along the passageway of the body portion 138 and engages the outer surface of the plunger 122. The second portion 140b maintains engagement with the outer surface of the plunger 122 as the plunger 122 moves between the retracted state and the extended state to maintain a seal at the plunger 122. For example, the second portion 140b may be compressed between the plunger 122 and the inner surface of the sleeve body 138 forming the passageway. Thus, an inner diameter of the second portion 140b may be less than or equal to the outer diameter of the plunger 122. Optionally, the inner diameter of the collar 140a may be substantially equal to the inner diameter of the second portion 140b so that the seal engages the outer surface of the plunger 122 along the passageway of the sleeve 136 and at least partially along the passageway of the housing 124.

Thus, the seal 140 is overmolded onto the sleeve body 138. The sleeve seals the plunger 122 with the sealing portion 140b that extends along the passageway of the sleeve body 138 and the sealing portion 140 seals the sleeve 136 against the lower housing 124 via the collar portion 140a extending from the first side 138a of the body 138. The opening or passageway in the lower housing 124a allows the hoop seal 140b to create a dust and water-tight seal along the passageway of the housing. One seal is between the housing and the sleeve along the passageway of the housing and another seal is between the sleeve and the plunger along the passageway of the sleeve.

Optionally, the seal 134 between the lower housing 124a and the upper housing 124b is disposed between the two housing portions and at least partially received along a channel 135 of the upper housing 124b. When the two housing portions are joined together, the seal 134 is received along the channel 135 and/or at least partially compressed between the lower housing 124a and the upper housing 124b.

The actuator is operable to move the door handle from a non-deployed position or state to a deployed position or state. For example, the actuator may be suitable for deploying a flush door handle from a recessed or flush state to the deployed state. The flush door handle may utilize aspects of the door handle assemblies and systems described in U.S. Pat. Nos. 11,746,575; 11,680,432; 11,441,338 and/or 8,786,401, and/or U.S. Publication Nos. US-2024-0035318; US-2023-0027125; US-2022-0341226; US-2022-0282534 and/or US-2021-0332619, which are all hereby incorporated herein by reference in their entireties. The door handle may comprise any type of door handle, such as a strap type handle or a paddle handle (having a paddle or handle portion that is pivotable about a generally horizontal pivot axis to open the vehicle door) and/or such as a handle assembly of the types described in U.S. Pat. Nos. 6,349,450; 6,550,103 and/or 6,907,643, which are hereby incorporated herein by reference in their entireties) or other type of vehicle door handle assembly. Optionally, the door handle assembly may include a soft touch handle portion, such as utilizing the principles described in U.S. Pat. Nos. 6,349,450; 6,550,103 and/or 6,907,643, incorporated above.

Although shown and described as being a generally horizontally oriented handle portion that moves laterally from the side of the vehicle, it is envisioned that the handle of the extendable flush door handle assembly may be oriented in any manner. For example, the handle may be oriented so that it is either vertical, horizontal, or diagonal with respect to the ground. Also, although shown and described as an exterior door handle for opening a side door or rear door or lift gate of a vehicle from exterior the vehicle, it is envisioned that the extendable flush door handle assembly may be suitable for use as an interior handle for opening a side door or rear door or liftgate of a vehicle from inside the vehicle.

Optionally, the door handle assembly or module may include or may be associated with an antenna for receiving signals from or communicating with a remote device. For example, the antenna (such as, for example, an antenna of the types described in U.S. Pat. No. 6,977,619 and/or U.S. Publication No. US-2010-0007463, which are hereby incorporated herein by reference in their entireties) may communicate a signal to the door locking system via a wire connection or the like, or wirelessly, such as via a radio frequency signal or via an infrared signal or via other wireless signaling means. For example, the handle assembly may include an antenna or sensor (such as an antenna and/or capacitive sensor) at the handle portion and/or may include a passive entry device or element. The antenna or sensor and/or passive entry device may receive a signal from a transmitting device (such as from a key fob or the like carried by the driver of the vehicle) and/or may sense or detect the presence of or proximity of a person or person's hand at or near the door handle, and may generate an output signal indicative of such detection. The actuator may be responsive to the antenna and/or sensor and/or device to impart an outward movement of the door handle portion so that the user can grasp the handle portion to open the door of the vehicle.

Such connections can include cables, wires, fiber optic cables or the like. The communication to the locking system may be via a vehicle bus or multiplex system, such as a LIN (Local Interconnect Network) or CAN (Car or Controlled Area Network) system, such as described in U.S. Pat. Nos. 6,291,905; 6,396,408 and/or 6,477,464, which are all hereby incorporated herein by reference in their entireties. The vehicle door may then be unlocked and/or the illumination source or sources may be activated as a person carrying a remote signaling device approaches the door handle. Optionally, other systems may be activated in response to the remote signaling device, such as vehicle lighting systems, such as interior lights, security lights or the like (such as security lights of the types disclosed in U.S. Pat. Nos. 6,280,069; 6,276,821; 6,176,602; 6,152,590; 6,149,287; 6,139,172; 6,086,229; 5,938,321; 5,671,996; 5,497,305; 6,416,208 and/or 6,568,839, all of which are hereby incorporated herein by reference in their entireties), or the vehicle ignition, or any other desired system.

Changes and modifications in the specifically described embodiments may be carried out without departing from the principles of the present invention, which is intended to be limited only by the scope of the appended claims as interpreted according to the principles of patent law.

1. A vehicular exterior door handle assembly, the vehicular exterior door handle assembly comprising:
a base portion configured to mount the vehicular exterior door handle assembly at a door of a vehicle;
a handle portion movable relative to the base portion;
wherein the handle portion comprises a grasping portion;
wherein, with the vehicular exterior door handle assembly mounted at the door of the vehicle, the handle portion is movable relative to the base portion between (i) a recessed position where the grasping portion of the handle portion is recessed at the base portion and not graspable by a user and (ii) a deployed position where the grasping portion of the handle portion protrudes outward from the base portion and is graspable by the user;
an actuator, wherein the actuator is electrically operable to move the handle portion between the recessed position and the deployed position;
wherein the actuator comprises (i) a housing, (ii) an electrically operable motor disposed within the housing and (iii) a plunger disposed partially within the housing;
wherein the plunger extends from within the housing along a passageway of the housing and partially exterior the housing;
wherein the actuator, when the electrically operable motor is electrically operated, drives the plunger axially along the passageway of the housing to move the handle portion between the recessed position and the deployed position; and
wherein the actuator comprises a sleeve within the housing, and wherein the plunger extends through the sleeve, and wherein the sleeve engages the plunger and an inner surface of the housing at or near the passageway to preclude moisture from entering the housing.

2. The vehicular exterior door handle assembly of claim 1, wherein the sleeve comprises a body portion and a sealing portion, and wherein the sealing portion engages the plunger and the inner surface of the housing.

3. The vehicular exterior door handle assembly of claim 2, wherein the body portion comprises a ramped interface, and wherein the ramped interface engages the housing to urge the sealing portion into engagement with the inner surface of the housing.

4. The vehicular exterior door handle assembly of claim 2, wherein the sealing portion comprises a rubber material overmolded with a non-compressible material of the body portion.

5. The vehicular exterior door handle assembly of claim 2, wherein the sealing portion comprises an O-ring that is compressed between the body portion and the inner surface of the housing.

6. The vehicular exterior door handle assembly of claim 1, wherein the sleeve comprises a collar that extends at least partially within the passageway of the housing.

7. The vehicular exterior door handle assembly of claim 6, wherein the collar comprises an outer diameter, and wherein the passageway of the housing comprises an inner diameter, and wherein the outer diameter is greater than the inner diameter.

8. The vehicular exterior door handle assembly of claim 6, wherein the collar is compressed between the plunger and a surface of the passageway of the housing.

9. The vehicular exterior door handle assembly of claim 1, wherein the sleeve comprises an inner cylindrical surface, and wherein the inner cylindrical surface engages the plunger.

10. The vehicular exterior door handle assembly of claim 1, wherein the housing comprises a first portion and a second portion that are joined together.

11. The vehicular exterior door handle assembly of claim 10, wherein the passageway is formed through the second portion of the housing.

12. The vehicular exterior door handle assembly of claim 10, wherein the passageway is disposed between the first portion and the second portion.

13. The vehicular exterior door handle assembly of claim 10, wherein a gasket is disposed between the first portion and the second portion.

14. The vehicular exterior door handle assembly of claim 1, wherein the inner surface of the housing extends in a direction transverse to a direction of the passageway.

15. The vehicular exterior door handle assembly of claim 1, wherein the inner surface of the housing comprises a surface of the passageway.

16. A vehicular exterior door handle assembly, the vehicular exterior door handle assembly comprising:
a base portion configured to mount the vehicular exterior door handle assembly at a door of a vehicle;
a handle portion movable relative to the base portion;
wherein the handle portion comprises a grasping portion;
wherein, with the vehicular exterior door handle assembly mounted at the door of the vehicle, the handle portion is movable relative to the base portion between (i) a recessed position where the grasping portion of the handle portion is recessed at the base portion and not graspable by a user and (ii) a deployed position where the grasping portion of the handle portion protrudes outward from the base portion and is graspable by the user;
an actuator, wherein the actuator is electrically operable to move the handle portion between the recessed position and the deployed position;
wherein the actuator comprises (i) a housing, (ii) an electrically operable motor disposed within the housing and (iii) a plunger disposed partially within the housing;
wherein the plunger extends from within the housing along a passageway of the housing and partially exterior the housing;
wherein the housing comprises a first portion and a second portion that are joined together, and wherein the passageway is formed through the second portion of the housing;
wherein the actuator, when the electrically operable motor is electrically operated, drives the plunger axially along the passageway of the housing to move the handle portion between the recessed position and the deployed position;
wherein the actuator comprises a sleeve within the housing, and wherein the sleeve comprises a body portion and a sealing portion; and
wherein the plunger extends through the sleeve, and wherein the sealing portion of the sleeve engages the plunger and an inner surface of the second portion of the housing at or near the passageway to preclude moisture from entering the housing.

17. The vehicular exterior door handle assembly of claim 16, wherein the body portion comprises a ramped interface, and wherein the ramped interface engages the first portion of the housing to urge the sealing portion into engagement with the inner surface of the second portion of the housing.

18. The vehicular exterior door handle assembly of claim 16, wherein the sealing portion comprises a rubber material overmolded with a non-compressible material of the body portion.

19. The vehicular exterior door handle assembly of claim 16, wherein the sealing portion comprises an O-ring that is compressed between the body portion and the inner surface of the second portion of the housing.

20. The vehicular exterior door handle assembly of claim 16, wherein the sealing portion of the sleeve comprises an inner cylindrical surface, and wherein the inner cylindrical surface engages the plunger.

21. A vehicular exterior door handle assembly, the vehicular exterior door handle assembly comprising:
a base portion configured to mount the vehicular exterior door handle assembly at a door of a vehicle;
a handle portion movable relative to the base portion;
wherein the handle portion comprises a grasping portion;
wherein, with the vehicular exterior door handle assembly mounted at the door of the vehicle, the handle portion is movable relative to the base portion between (i) a recessed position where the grasping portion of the handle portion is recessed at the base portion and not graspable by a user and (ii) a deployed position where the grasping portion of the handle portion protrudes outward from the base portion and is graspable by the user;
an actuator, wherein the actuator is electrically operable to move the handle portion between the recessed position and the deployed position;
wherein the actuator comprises (i) a housing, (ii) an electrically operable motor disposed within the housing and (iii) a plunger disposed partially within the housing;
wherein the housing comprises a first portion and a second portion that are joined together, and wherein a gasket is disposed between the first portion and the second portion;
wherein the plunger extends from within the housing along a passageway of the housing and partially exterior the housing;
wherein the actuator, when the electrically operable motor is electrically operated, drives the plunger axially along the passageway of the housing to move the handle portion between the recessed position and the deployed position;
wherein the actuator comprises a sleeve within the housing, and wherein the plunger extends through the sleeve; and
wherein the sleeve comprises a collar that extends at least partially within the passageway of the housing, and wherein the collar engages the plunger and a surface of the passageway to preclude moisture from entering the housing.

22. The vehicular exterior door handle assembly of claim 21, wherein the sleeve comprises a ramped interface, and wherein the ramped interface engages the housing to urge the collar into engagement with the surface of the passageway.

23. The vehicular exterior door handle assembly of claim 21, wherein the collar comprises an outer diameter, and wherein the passageway of the housing comprises an inner diameter, and wherein the outer diameter is greater than the inner diameter.

24. The vehicular exterior door handle assembly of claim 21, wherein the collar is compressed between the plunger and the surface of the passageway of the housing.
